(19) United States
(12) Patent Application Publication
(10) Pub. No.: US 2018/0032548 A1
(43) Pub. Date: Feb. 1, 2018

(54) Data Structure, Model for Populating a Data Structure and Method of Programming a Processing Device Utilising a Data Structure

(71) Applicant: MILLIEABLE IP PTY LTD, Western Australia (AU)

(72) Inventor: Benjamin Seidel, Western Australia (AU)

(21) Appl. No.: 15/550,382

(22) PCT Filed: Feb. 12, 2016
(86) PCT No.: PCT/AU2016/050095

§ 371 Date: Aug. 11, 2017

(30) Foreign Application Priority Data
Feb. 13, 2015 (AU) 2015900480
Nov. 24, 2015 (AU) 2015904853

(51) Int. Cl. G06F 17/30; G06F 3/0484

(52) U.S. Cl. CPC G06F 17/30292; G06F 17/30365; G06F 17/30525; G06F 17/30646; G06F 17/30604; G06F 3/04842

(57) ABSTRACT

A data structure for software comprising a table of attributes. Each record of the attributes table includes additional information, such that application code of the software is only able to reference the data value associated with the attribute as stored in the database schema by way of the attributes referenced in the data structure. In this manner the database schema thereby able to independently determine how to implement the attribute records.

### FIELD OF THE INVENTION

The invention relates to a data structure, a model for populating a data structure and method of programming a processing device utilising a data structure. The data structure facilitates independence of the application code from the database schema containing the data necessary for the general operation of the application. The model provides a means of identifying and rationalising the data needed for the general operation of the application in a manner that facilitates easy population of the aforementioned data structure so as to provide such independence from the application code.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

The design of computer software starts with an idea. The functionality behind this idea may be simple or complex, but an almost truism to software development is that the functionality of the final software is often very different from the functionality behind the initial idea due to “feature creep”. Yet even when “finalised”, computer software is often subject to further changes due to the need for bug fixing and/or the need to introduce yet further functionality.

Both “feature creep” and post-finalisation modification creates problems for designers and developers. Designers need to be able to design the desired changes without adversely impacting on existing functionality or introducing new bugs into the software. At the same time, the new design must be technically possible within the constraints of the programming language used to create the software or the operating system on which the software is intended to run.

When the software is relatively small, the aforementioned challenges generally do not pose an issue. However, if the software is of significant size, the actual size and complexity of the software's database schema and application code can not only inhibit the introduction of bug fixes or new functionality, but also prevent the schema or code from being optimised.

To elaborate, change the database schema and the application code may either no longer be able to access a database table, or may access incorrect data. Change the application code such that it requires access to new data or requires a change to existing data, and the application code may need to modify the database schema. Even if a change to the database schema is not required, at the very least, such a change requires that:
all other elements of the application code which reference the new data or changed data must be verified to ensure that all references are consistent with each other and the database schema; and
at each data entry point, the data is subjected to the same, or at least a consistent, validity check.

As a result of this interrelationship between the application code and the database schema quite often designers seek to optimise one at the expense of the other.

It is therefore an object of the present invention to create a method of designing software which breaks this interdependence between the application code and the database schema.

### DATABASE DESIGN

In order to facilitate a proper understanding of the invention, it is important to understand certain fundamentals of database design as described hereafter.

Historically, the primary modelling tool for database has been the Entity-Relationship Model (“ERM”, also known as the Entity-Relationship Diagram). The ERM sets out each “entity” that is a participant in the intended software and its association, if any, to each other “entity” (such associations are referred to as “relationships”). In doing so, it presupposes three possible relationships:
The first “entity” has a singular association with the other “entity” (also known as a 1:1 relationship);
The first “entity” may be associated with multiple instances of the other “entity” (also known as a 1:N relationship); OR
Multiple instances of the first “entity” may be associated with multiple instances of the other “entity” (also known as an M:N relationship).

The identification of each “entity” and its associated relationships then forms the initial schema for the database layer.

The initial schema is then sought to be optimised using techniques such as normal forms. However, this optimisation only applies to the initial schema—any subsequent modifications to the schema may result in the schema no longer complying with one or more of the normal forms with associated performance consequences.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the present invention there is a data structure for software comprising a table of attributes, where each record of the attributes table includes additional information, such that application code of the software is only able to reference the data value associated with the attribute as stored in the database schema by way of the attributes referenced in the data structure, the database schema thereby able to independently determine how to implement the attribute records.

The software may further include a table of entities, each record of the attributes table also referencing a records of the entity table, the database schema operable to independently determine the implementation of the relationship between the data stored in relation to the entity records and attribute records.

Preferably, the data structure is implemented in a third data store.

The first records of the entity table are, ideally, a reference to the existence of the entity table and the attributes table.

Each record in the attributes table preferably includes fields that define a Boolean expression or function. This Boolean expression may include a reference to an attribute in the attributes table that itself references a further Boolean expression.

The data structure may also comprise a form table linked to a set of records in a first field table, each record in the set of records being associated with a record in the attributes table such that the application code is able to use the data contained in the form table and first field table to create a desired form as and when needed.

The data structure may also comprise a report table, the report table linked to a set of records in a second field table, each record in the set of records being associated with a record in the attributes table such that the application code is able to use the data contained in the report table and second field table to create a desired report as and when needed.

Where a report table or form table comprises part of the data structure, the data structure may also include a format table, each record in the format table include formatting information in respect of an element of either a record in the form table or a record in the report table.

The data structure may also include one or more tables for recording application behaviour details.

The attributes table may further include a field, the value of which indicates to the application code whether it is permitted to change the data value of that attribute. Furthermore, the attributes table may further include a field, the Boolean expression used to evaluate the field value is representative of the data integrity rules for that attribute.

In accordance with a second aspect of the invention there is a method of populating a data structure for software according to the first aspect of the invention comprising the steps of:
identifying entities related to the software;
identifying attributes for each identified entity;
identifying relationships between identified entities;
modifying all identified relationships such that only 1:N relationships exist between identified entities;
adding an attribute to each identified entity on the N side of a 1:N relationship being a reference value to a record from the other identified entity of the 1:N relationship; and
adding a new record to the entities table representing each entity identified according to the preceding steps;
adding a new record to the Attributes Entity representing each attribute identified according to the preceding steps and associating the attribute with the corresponding record of the entities table matching the entity the attribute is identified with.

The method may further include the step of modifying all identified relationships such that only 1:N relationships exist between identified entities includes the substep of eliminating all 1:1 relationships between identified entities by combining the two identified entities into a single entity.

The step of modifying all identified relationships such that only 1:N relationships exist between identified entities may include the substep of eliminating all M:N relationships between identified entities by transforming the relationship into its own entity with a 1:N relationship back to the original identified entities.

The method may include the step of identifying at least one summary attribute for at least one entity. Similarly, the method may further include the step of identifying at least one simple attribute for at least one entity.

The method may further include the step of creating as the first records in the entity table a record relating to the entity table and a record relating to the attribute table.

In accordance with a third aspect of the invention there is software recorded on a computer readable medium that, when executed by an appropriate processing device utilises a data structure according to the first aspect of the invention. Preferably, the data structure is implemented in a third data store.

Preferably, the application code operates to execute an initialisation procedure, the initialisation procedure operable to read the first records of the attributes table. Alternatively, the application code operates to execute an initialisation procedure, the initialisation procedure operable to read the first records of the entity table and thereby provide the application code with details of the entity table and the Attributes Entity for future referencing.

Queries for data values from the database schema may require a first query of the attributes table with at least some of the results of the query being used as the basis for a second query of the database schema. Furthermore, the second query may be made through a translator module 24, the translator module 24 operable to translate the second query into an appropriate query of the database schema.

The translator module 24 may execute the queries through a set of load functions. Each load function may require execution parameters in the form of an attribute identified in the attributes table and a record.

The information obtained from the set of load functions is used to:

determine the relevant table in the database schema;

determine the referential position of the relevant table in the database schema; and

determine the type function to be returned.

The application code and database schema may incorporate synchronisation means for synchronising with the data structure.

In accordance with a fourth aspect of the invention there is software recorded on a computer readable medium that, when executed by an appropriate processing device, allows a user by way of a graphical user interface to:

identify entities related to the software's intended function;

identify attributes for each identified entity;

identify relationships between identified entities;

modify all identified relationships such that only 1:N relationships exist between identified entities; and

add an attribute to each identified entity on the N side of a 1:N relationship being a foreign key back to the other identified entity of the 1:N relationship,

the software further including populating means, the populating means operable to add a new record to the entities table representing each identified entity and add a new record to the Attributes Entity representing each identified attribute and associate the identified attribute with the corresponding record of the entities table matching the entity the attribute has been identified with.

### BRIEF DESCRIPTION OF THE DRAWINGS

The invention will now be described, by way of example only, with reference to the accompanying drawings, in which:

FIG. 1 is a schematic representation of a data structure according to the invention.

FIG. 2 shows an illustrative example of the data structure shown in FIG. 1.

FIG. 3 is a flow chart showing how to add a new attribute to the data structure shown in FIG. 1.

FIG. 4 is a flow chart showing how to remove sparse data from a database schema.

FIG. 5 is a flow chart showing how to remove repetitive data from a database schema.

FIG. 6 is a schematic of a method of populating a data structure as shown in FIG. 1.

FIGS. 7 to 9 are illustrative examples of the steps of the method as shown in FIG. 6.

FIG. 10 is schematic representation of a data structure according to a third embodiment of the invention.

FIG. 11 is a schematic representation of software for facilitating the method of populating a data structure as described in FIG. 6.

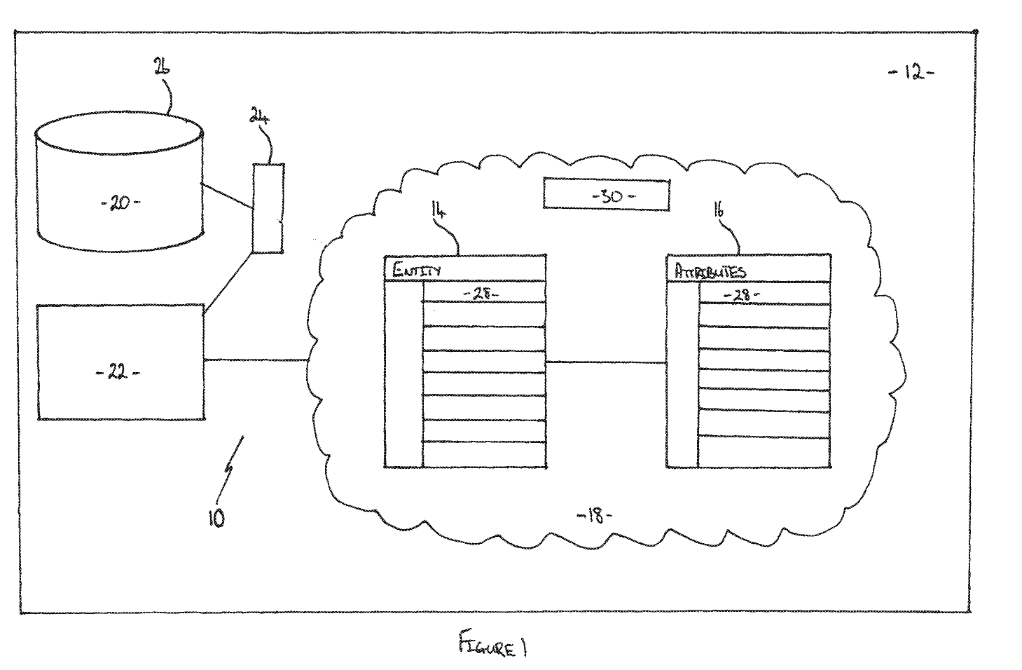

### DEFINITION

For the purposes of illustration of this invention, the following embodiments are described in the context of a relational database. However, the invention can readily be implemented in the context of object graph databases or two-value or three-value stores.

In the context of these latter implementations, and other implementations that may be developed in future—and for the purpose of this specification and accompanying claims—it should be appreciated by the person skilled in the art that references to the terms below should be read as follows:

Record=a set of associated values. Each Record is typically associated with a Table and each associated value in the set of associated values correlates with a Field of that Table. Taken from the view of the application code, a set of Records can also be a virtual representation of a Table.

Table=an abstract collation of the underlying Records as implemented by the database schema. To facilitate understanding of a Table, the Table is typically represented visually as a table of fields (the label given to each field commonly depicted as a column header of the Table).

Field=a label of a data value within a data record. Each Field is of a defined type which facilitates understanding of the data value (e.g. a string of characters, an integer value, a Boolean value)

Entity=A virtual representation of a Table, accessible by the application code. Each Entity must be implemented within this invention as a Record within a primary Entity.

Attribute=A virtual representation of a Field, accessible by the application code. Each Attribute is implemented within this invention as a Record within the Attributes Entity. Attributes may have fixed values that are stored in the underlying database schema or be calculated according to an associated function.

### PREFERRED EMBODIMENTS OF THE INVENTION

In accordance with a first aspect of the invention there is a data structure 10 for software 12. In this embodiment, the data structure 10 comprises two database tables 14, 16. The first database table 14 is referred to hereafter as the primary entity 14. The second database table 16 is referred to hereafter as the Attributes entity 16. Each record of the Attributes entity 16 must be associated with a record in the primary entity 14.

The database in which the primary and Attributes entities 14, 16 are implemented using a database engine referred to hereafter as the third data store 18.

The primary and Attributes entities 14, 16 are implemented in a third data store 18. The third data store 18 is a program that has characteristics and performs operations similar to a database engine. The third data store 18 provides a set of public functions that may be used by application code 22. The interface defined by these public functions include update mechanisms to control and alter the behaviour of the application code 22. The third data store 18 must reside within the working memory of the processing device (not shown) designated to execute the set of associated processes.

The actual records of the primary and Attribute entities 14, 16 contain data values representing the possible interactions between the application code 22 and database schema 20. In particular the data values represent what data the application code 22 can request.

It is to be noted that it is not intended for the third data store 18 to contain information about how data in the database schema 20 may be accessed or modified at a technical level. It is rather intended to contain information on what data in the database schema 20 may be accessed or stored.

The third data store 18 also incorporates a set of executable instructions that define a bootstrap procedure. The bootstrap procedure is executed only on establishment of a communication link between application code 22 and the third data store 18.

The application code 22 is a set of modules for completing various tasks. While the modules in the set of modules can vary, the set must include a translator module 24.

The translator module 24 exposes a load function and a commit function to the third data store 18. The load function requires two parameter to be passed to it. The first parameter is an Attribute, while the second is a Record. The load function returns an object.

The commit function will be described in more detail below.

It is to be noted that the translator module 24 is the only element of the application code 22 that requires information specific to the underlying database schema 20. As such, the translator module 24 is intended to form part of the standard library of the application environment (not shown) used to generate the application code 22. The role of the translator module 24 will be further described below.

On execution of the application code 22, the first task undertaken is to run a connection module (from the set of modules) to establish a communication link with the third data store 18. Once the communication link has been established, the third data store 18 executes the bootstrap procedure.

Execution of the bootstrap procedure operates to communicate the records associated with the primary entity representing both the primary entity itself and the Attributes entity to the application code 22 through the newly established communication link. These communicated records are referred to hereafter as the initialisation records.

The application code 22 must then create three new Attributes in the Attributes entity 16. Note that, in order to do this, the application code 22 must have knowledge of at least the existence of the Attributes entity 16 in the third data store 18.

The first Attribute created is a query attribute. The query attribute references a localised query function of the third data store 18.

The second and third Attributes are identity functions. While the function may differ in it's implementation, each identity function must evaluate to a true Boolean value. The difference between the second and third Attributes lies in the second Attribute being an Attribute associated with the primary entity 14 while the third Attribute is an Attribute associated with the Attributes entity 16.

The first and third Attributes are defined within the Attributes entity 16 as an attribute of the Attributes entity 16. The second Attribute is defined within the Attributes entity 16 as an attribute of the primary entity 14.

The records within the primary and Attributes entity 14, 16 can then be retrieved through the following functions:

LOAD (first Attribute, second Attribute)
{To obtain all of the records of the primary entity 14}

LOAD (first Attribute, third Attribute)
{To obtain all of the records of the Attributes entity 16}

Note here that the reference to the load function is not a reference to the load function of the translator module 24. Rather it is a reference to the load function of the third data store 18.

The records retrieved from these two commands are then used by the application code 22 to create a data model that references what data (i.e. attributes) the application code 22 can request. This data model is consigned to the working memory of the application code 22.

Ideally, the remaining modules in the set of modules have no or very little “hard-coded” business logic. Rather, it is the intent of this invention that the remainder of these modules 22 comprise queries of the third data store 18 and data calls (such as commands to change a data value, create a record or delete a record). Each data call is typically reactive to the data values received from an earlier query of the third data store 18 or environmental considerations (such as external input).

Before a query can be made of the third data store 18, the query criteria must be resolved down to a Boolean value. Where the query criteria is based on an attribute which itself records Boolean values, this poses no issue. However, where the attribute(s) do not record Boolean values, a temporary Boolean attribute must be created.

The temporary Boolean attribute is defined according to the function of the contemplated query. Examples of how to define the most common contemplated queries are set out below.

### Comparator Functions

Comparator functions include checks to see whether an attribute has a data value equal to, in excess of or less than a specified value.

The temporary Boolean attribute that facilitates a comparator function query comprises three elements referred to as Right Hand, Left Hand and Operator. These elements are to reference values according to the following expression:

[Left Hand] [Operator] [Right Hand]=Boolean value

In this approach, at least one of the Left Hand or Right Hand element must be an attribute recorded in the Attributes entity 16. Where both the Left Hand and Right Hand element are both attributes recorded in the Attributes entity 16, they must be associated with the same record of the primary entity 14.

### “AND”/“OR” Functions

The temporary Boolean attribute that facilitates an “AND/OR” function query comprises two elements: Operator and List. The List element consists of a set of data values and is typically obtained through the execution of an earlier query. The elements are used to evaluate to a Boolean value as follows:

[List₁] [Operator] [List₂] [Operator] . . . [Operator] [List_{N}]=Boolean value

### Range-Based Functions

The temporary Boolean attribute that facilitates a range based function query comprises four elements referred to as Right Hand, Mid, Left Hand and Operator. These elements are to reference values according to the following expression:

[Left Hand]<=[Mid]<=[Right Hand]=Boolean value

In this approach, the Mid element must be an attribute recorded in the Attributes entity 16. If one of the Left Hand or Right Hand elements is also an attribute recorded in the Attributes entity 16, they must also be associated with the same record of the primary entity 14 as the Mid element.

### Stepping Functions

Stepping functions allow values to be retrieved through a N:1 relationship as described in the AER. The stepping function uses two attributes, a linking value and a remote value, where the linking value contains a record from an entity, and the remote value belongs to that entity. Using C's pointer dereferencing notation:

[linking value]->[remote value]=value

### Summary Functions

Summary attributes allow the summarising of sets of values from an associated 1:N relationship as described in the AER (see below). The set of records is taken from an inversely-related entity using a linking filed from the related table back to the original table. Each record that occurs in the set then has a value extracted from them using a to summarise field. This set of values is then passed to the summarising function, to produce a single value, using the formula:

Summarising Function([Linking filed], [to summarise field])=Value

It should be readily apparent to the person skilled in the art as to how to modify the function-based queries described above to implement yet other types of function-based queries.

Note that, in almost all cases, the temporary Boolean attribute must be defined as an attribute of the same Entity in the primary entity 14 as the defining attribute used in the Boolean expression.

The query then progresses to a second stage where the query makes use of the temporary Boolean attribute and a Query attribute. The Query attribute is preferably the same Query attribute as used to facilitate loading of the initialisation records.

The Query attribute controls the execution of the query function by submitting the temporary Boolean attribute thereto as an execution parameter. At a theoretical level, the query function then determines the Entity associated with the temporary Boolean attribute. Once determined, the query function iterates over the records of the associated Entity, resolving the Boolean expression as defined by the temporary Boolean attribute. If resolution of the Boolean expression results in a “TRUE” evaluation, the evaluated record is added to the resultant set of records that makes up the data value of the Query attribute.

As the records of the associated Entity are held in the database schema 20 and not in the third data store, actual retrieval of the data values is achieved as follows. On execution of the query function by the Query attribute, the third data store initiates a load event. Initiation of a load event sends a signal back to the translator module 24 to execute its load function.

As discussed, the load function of the translator module 24 requires two parameters—attribute and record. The attribute and record parameters must be associated with the same Record from the primary entity 14.

The Query attribute is used as the attribute parameter, while the temporary Boolean attribute is used as the record parameter. Through a series of additional function calls specific to the implementation of the database schema, the translator module 24 operates to, in order:

determine the Entity record in the primary entity 14 associated with the Boolean expression that is the data value of the temporary Boolean attribute.

determine the referential position in the database schema of the records associated with the determined Entity. Note that in an SQL-based data schema, as described, this can merely be a reference to the name of the table associated with the determined Entity; and

determine the type of function to be executed based on an assessment of the data value of the temporary Boolean attribute.

This information is then used to build an appropriate query in the query language utilised by the database engine hosting the database schema 20. The built query is then executed.

Note that the value to be returned by the translator module 24's load function must be of the same type as the type defined for the attribute parameter. Hence, if the executed query returns a value of a differing type, the translator module 24 will be required to manipulate the returned value to convert it to the appropriate type.

The application code can then access the query results by dereferencing the reference returned by the query call.

When the application code 22 needs to update a data value in the database schema 20, this is also achieved by way of the translator module 24 24. The application code needs to send the update command in the form of a “Change” command to the third data store. The third data store then reformats the “Change” command into a call of the Commit function of the translator module 24.

On receipt of this call form the third data store, the translator module 24 parses the call and reformats it into a command in the native language of the database engine 26. The reformatted command is then executed by the database engine 26 to update the appropriate data value(s).

As can be appreciated by the person skilled in the art, a similar process is followed when the application code 22 needs to create a new record, although in this case the command used is an “Insert” command rather than a “Change” command.

Because the application code 22 relies on the data model as formed by the primary and Attribute entities 14, 16 in the third data store 18, any changes to these entities 14, 16 must be synchronised with both the application code 22 and the database schema 20. Synchronisation of the database schema 20 with the third data store 18 is not intended to be a complete synchronisation. Rather it is a synchronisation only to the extent that is necessary to allow the translator module 24 to make appropriate data calls in future.

In this embodiment, to facilitate synchronisation, whenever an operation is performed that changes the third data store, the date and time of the change is recorded. Furthermore, the application code 22 and database engine 26 also record the date and time when they last synchronised with the third data store 18. If the application code 22 determines during a periodic check that the third data store 18 has a recorded date/time later than the date/time recorded for synchronisation of the application code 22, then the application code 22 immediately commences a synchronisation with the third data store 18. An identical process is followed to ensure synchronisation of the database schema 20.

While the above description shows the technical aspects utilised by the present invention to perform data queries, as indicated the objective of the present invention is to provide a database schema 20 that is able to be modified without adversely impacting the application code 22. Accordingly, the following description illustrates how this is achieved at a similar technical level.

If the application code 22 requires an additional attribute, a new record 28 is added to the Attribute entity 16. As the new record 28 represents a new Attribute, to avoid confusion we will refer to it hereafter as “New Attribute”

In addition to describing the New Attribute 16, the new record 28 also specifies the entity in the primary entity 14 to which the new Attribute 16 relates. Once the new record 28 has been established, the third data store 18 also operates to create a new time stamp for the third data store 18.

When the database schema 20 performs its next synchronisation check against the third data store 18, details of this time stamp are retrieved and compared to the time stamp recorded by the database schema 20. If the time stamp of the third data store is later than the time stamp recorded by the database schema 20, the database schema 20 initiates a synchronisation action. Following synchronisation, the database schema 20 operates to store and reference data values associated with the New Attribute. The database engine 26 that underlies the database schema 20 has unfettered discretion as to do this.

For example, if New Attribute is being added to an entity represented by a small table in the database schema 20, New Attribute may be added by way of a direct command to the database engine 26 to alter that table's definition to include a new field. However, if New Attribute is being added to an entity represented by a large table, an alternative course of action is to create a new table solely containing New Attribute as a field thereof along with a foreign key to the original table. The new table is then related back to the large table so that the two tables are joined whenever an appropriate request for information from the entity associated with the large table is made.

A yet further alternative means of adding New Attribute is to create a new table associated with the entity to which New Attribute relates. The new table has a structure identical to that of the original table, ie. it has fields representing all of the attributes of the original large table plus a new field representing New Attribute. Following creation, all of the data values of the records of the original table are used to populate the corresponding records of the new table. This can be done on a periodic scheduled basis or as a batch update.

When the database engine 26 notes that the data values of a field associated with an attribute are identified as populated below a set threshold (for example, 0.1% of the total records have a data value for the field associated with the attribute), the database engine 26 may elect to remove the field associated with the attribute from its current table and move it into a new table. The new table can then be joined by the database engine 26 to the original table as and when required.

Note that the aforementioned modifications requires similar modification to the database schema 20. However, due to the independence of the database schema 20, there is no requirement for the database engine 26 to advise the third data store 18 or the application code 22 of how this change has been implemented.

It should be further appreciated by the person skilled in the art that the ability for the database schema 18 to act independently in optimising the tables and data stored therein allows for more efficient use of computational resources. For instance, where the software 12 operate across multiple storage devices (not shown), data that is rarely accessed can effectively be archived by storing it on storage devices with slower access speeds. This, in turn, then frees up storage on storage devices with higher access speeds for more frequently accessed data/tables and thus the performance of the software 12 as a whole.

In accordance with a second embodiment of the invention, where like numerals reference like parts, there is a model 200 for populating a data structure 10. The model 200 of this invention will hereafter be referred to as the “Atomic Entity Relationship” (AER) model. The AER model 200 is a variant on the ERM model.

In the AER model 200, entities 202, their attributes 204 and their relationships 206 are all identified as per the standard ERM model. However, once the relationships 206 have been identified under the AER model 200 they are subject to a further review.

Where two entities 202 are linked through a 1:1 relationship 206, the entities are combined on the basis that one can only exist if the other exists and hence are the same entity 202 that has been incorrectly split into two.

Similarly, where two entities 202 are linked through a M:N relationship 206, the relationship 206 itself is split into its own entity 202. This is because there is no way to identify and manipulate each individual relationship 206. The new entity 202 has a 1:N relationship 206 back to each of the original entities 202 of the M:N relationship 206.

Thus, in the AER model 200, the only relationships 206 that exist are 1:N relationships 206.

To facilitate visual understanding of entity relationships 206 in the AER 200 by the modeller (not shown), each relationship 206 is referred to in the diagram as an attribute 204 of the unitary entity 202 (i.e. the entity 202 bearing the one element of the 1:N relationship 206). An arrow 208 is then drawn between this attribute 204 and the related entity 202.

The AER model 200 further allows for both simple and summary attributes 210. A simple attribute 210 is ascribed a value based on a function that involves the value ascribed to at least one or more attribute 204. A summary attribute 210 uses a relationship 206 to another entity 202 to produce a list of related entities 202.

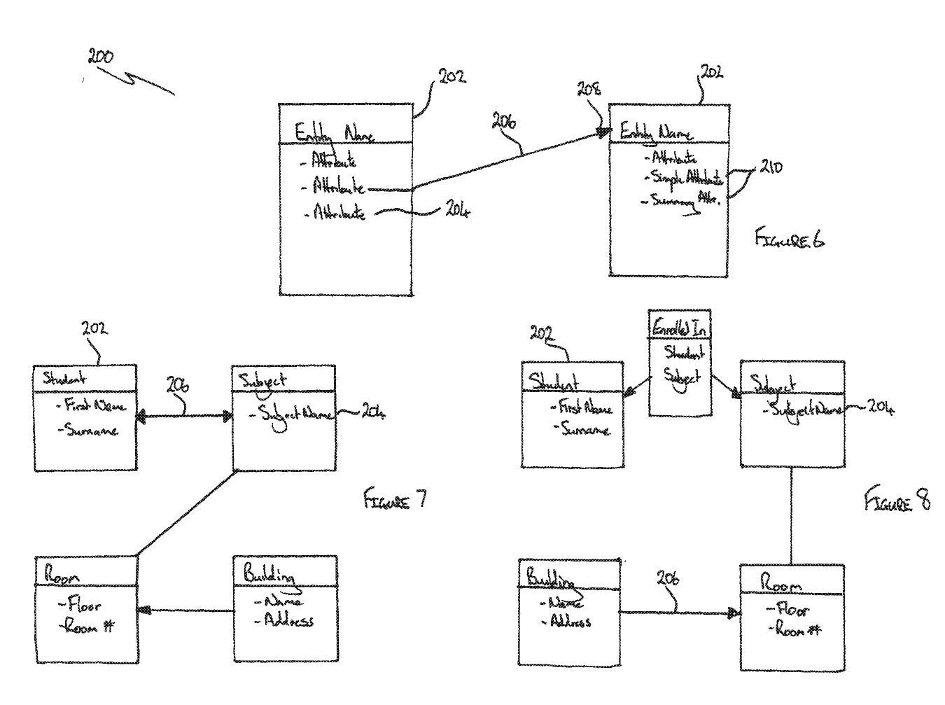

This AER model 200 is shown schematically in FIG. 6.

This embodiment will now be described in the context of the example given for the first embodiment.

As described in the first embodiment, there are four entities 202, namely:

Student;

Subject;

Room; and

Building.

Under the standard ERM, the relationships between these entities 202 can be described as follows:

Many students can enrol in many subjects (M:N relationship);

A subject is taught solely in one room (1:1 relationship); AND

A building has many rooms (1:N relationship).

Similarly, the only attributes for these entities 202 are as follows:

Student—first name, surname.

Subject—subject name.

Room—floor, room number.

Building—name, address.

Under the AER model 200, the first step is to identify and combine all 1:1 relationships 206. As a result, the entities 202 Subject and Room are now combined into a single entity 202, Subject. (See FIG. 7).

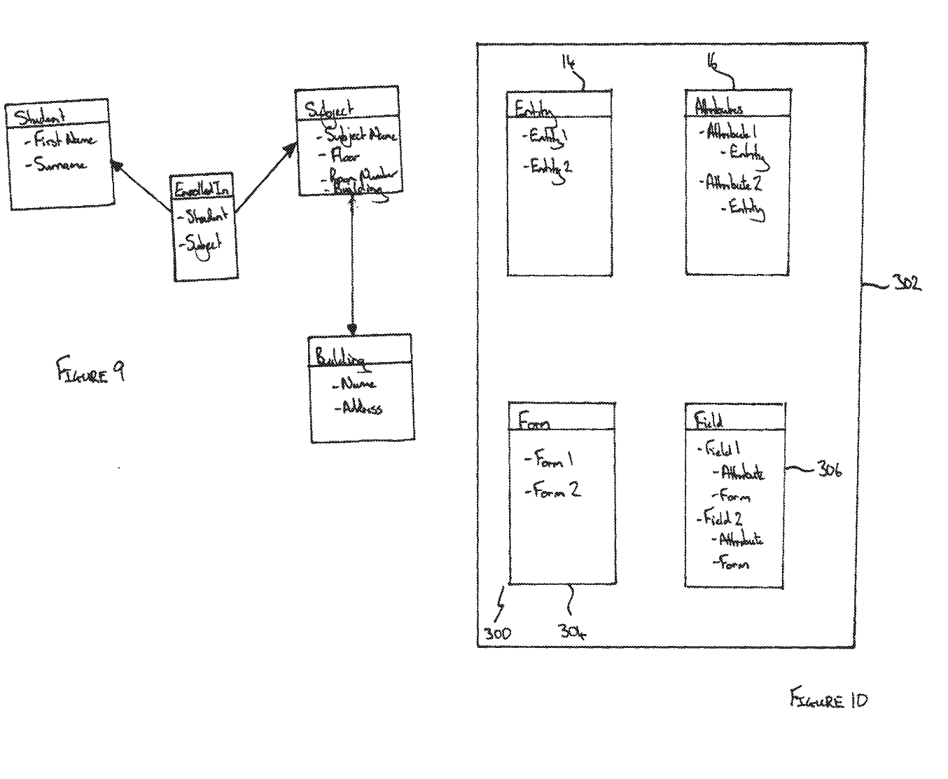

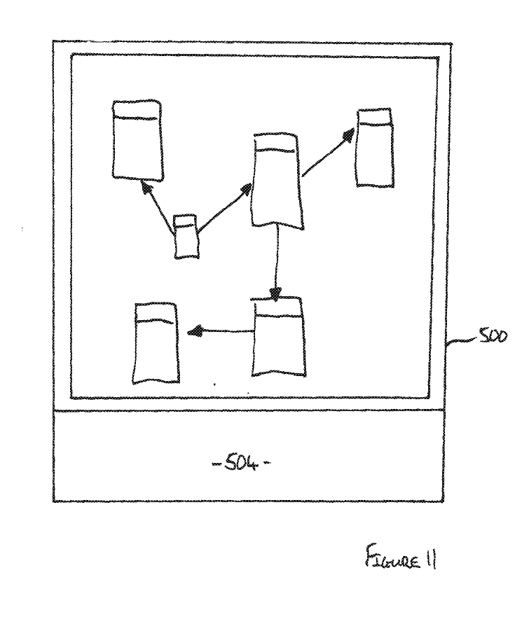

Following combination of the Subject and Room entities 202, all M:N relationships 206 are identified and decomposed into 1:N relationships 206 as shown in FIG. 8 (i.e. the Student/Subject relationship). This sees a new entity 202 called Enrolled In to be formed. The relationship between the entity Subject 202 and the new entity Enrolled In 202 is now a 1:N relationship 206 (i.e. a Student can be enrolled in many things). The relationship between the entity Subject 202 and the new entity Enrolled In 202 is also now a 1:N relationship 206 (i.e. a Subject may have many enrolments).

The rationalised relationships 206 are now converted into attributes 204 of the N-side entity 202 to which they relate. This means that the new attributes 204 for the entities 202 in the AER model 200 are now as follows:

Student—first name, surname.

Subject—subject name, floor, room number, Building.

Enrolled In—Subject, Student.

Building—name, address.

This finalised AER model 200 is shown in FIG. 9.

To populate the data structure 10, two initialisation records are entered as the first records in the primary entity 14 of the data structure 10.

The first initialisation record 212 acts as a self-referential record, i.e. it informs of the existence of the primary entity 14 within the third data store 18. The second initialisation record 212 is a record referential of the Attributes entity 16, i.e. it informs of the existence of the Attribute table 16 within the third data store 18.

With the initialisations records 212 recorded, the remaining records of the primary entity 14 are populated with the entities 202 identified in the AER model 200. The remaining records of the Attributes entity 16 are also populated with the attributes 204 of the entities 202 identified in the AER model 200.

To ensure that the identified attributes 204 retain their association with the identified entities 202, the Attributes entity 16 has a field entitled Associated Entity. As each attribute 204 identified in the AER model 200 is recorded into the Attributes entity 16, the Associated Entity field is also populated with details of the entity 202 to which the recorded attribute 204 relates.

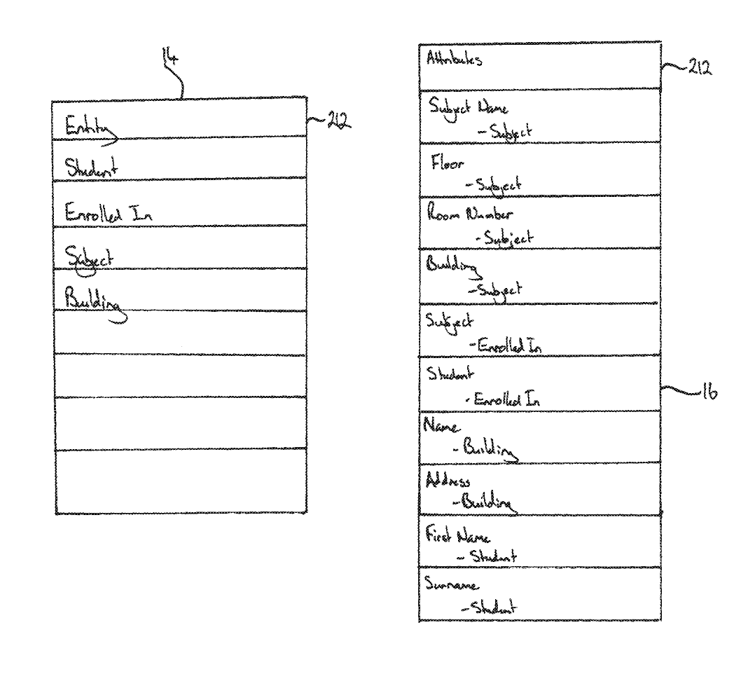

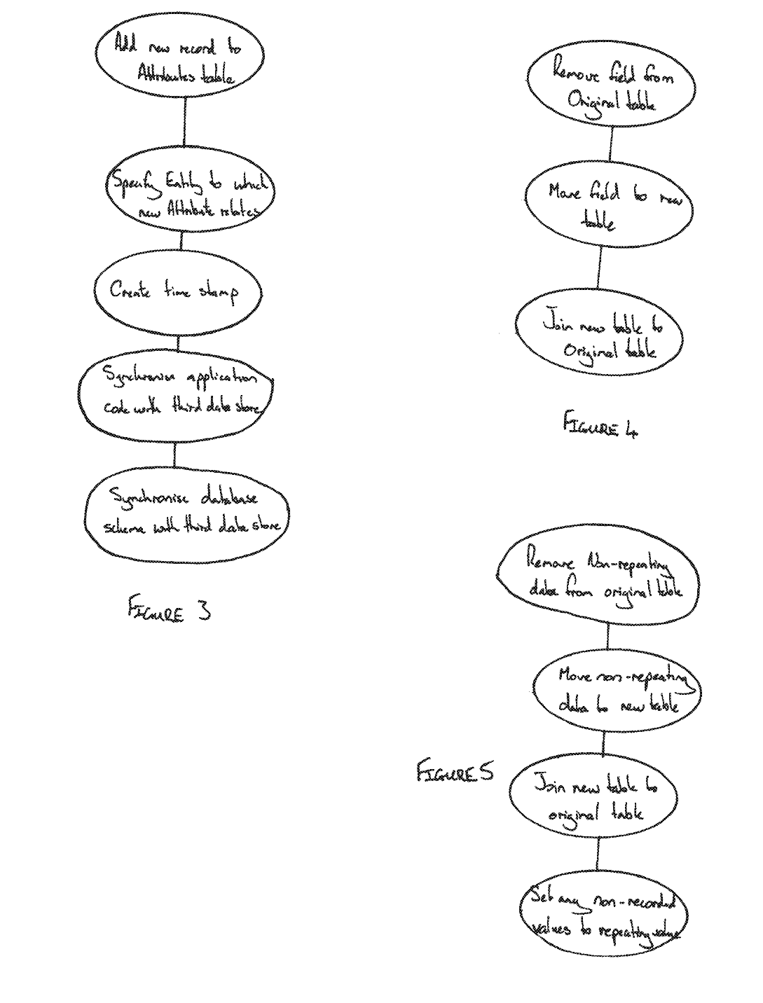

As populated, the resulting data structure 10 is as shown in FIG. 2.

If at a later stage a change is made such that a Subject may be held in differing rooms at different times of the year, changes need to be made to the AER model 200. However, both the populated data structure 10 and the application code 22 utilise the Subject. Room and Subject. Floor attributes 204 to direct students to the correct rooms.

To accommodate the variations, the entity Room 202 is restored into the AER 200 as a proposed 1:N relationship 206 with the entity Subject 202 (i.e. that a Room can now be used for multiple Subjects depending on the time of year). The new Room entity 202 has the attributes Room Number and Floor 204 as originally existed in the Subject entity 202 and a further attribute Date Range 204.

A new attribute 204, Room, is introduced into the Subject entity 202 to effect implementation of the 1:N relationship 206.

As the use of the room is time dependent, the existing room and floor attributes 204 now become summary attributes 210 that utilise the relationship between the Room entity 202 and Subject entity 202 to determine their appropriate values.

To implement this change and appropriately populate the data structure 10, the new Room entity 202 is added to the Entity table 202 of the third data store 18. At the same time, the attributes being modified are identified and the associated foreign key changed to the new table. In this case, this means modifying the Room Number attribute such that its association with the Subject entity is changed to an association with the Room entity 202.

With the third data store 18 appropriately updated, the database engine 26 modifies the database schema 20 by firstly copying all of the data values for the Subject.Floor and Subject.Room Number fields over to become the data values for the corresponding fields of the Room table. When a data call is subsequently made for the Subject.Floor and Subject.Room Number fields a comparison is made between the current date and the data value of each associated Room record's Data Range field to identify the correct Room record. The data values of the correct Room record are then returned to form the data values of the Subject.Floor and Subject. Room Number fields.

In accordance with a third embodiment of the invention, where like numerals reference like elements, there is a data structure 300 and software 302 implementing the data structure 300. The data structure 300, is an enhanced version of the data structure 10 as described in the first embodiment.

To elaborate, the third data store 18 includes not only the primary and Attributes entities 14, 16, but also a Form entity 304 and a Field entity 306.

Each record in the Form entity 304 represents a type of form that is used by the software 302 to get data from a user (not shown). Each record in the Field entity 306 represents a field used for data entry in a form. In a manner akin to the implementation of the Attributes entity, each record in the Field entity 306 includes a field (attribute) that links the Field record to its associated Form record. However, each record in the Field entity 306 also includes a field (attribute) that links the Field record with at least one associated Attribute record.

The application code 22 is then able to use the data associated with the Form and Field entities to create forms as and when needed.

Yet further embodiments of the invention can be formed in a similar manner. For example, details of reports needed to be generated by the software 302 may be implemented in an almost identical manner to that described above for forms.

In yet further embodiments of the invention, other data driven elements of the software 302 may be atomised and included as tables and/or attributes within the third data store 18 in a similar manner to that already described. Examples of such data driven elements include form and report formats and application behaviour. As the method of implementation of these data driven elements may vary according to the person(s) designing the software 302, no further explanation of their implementation will be provided here.

In accordance with a fourth embodiment of the invention, where like numerals reference like parts, there is software 400 comprising a graphical user interface 402. The graphical user interface 402 allows the user to define entities, attributes and relationships and then vet the defined entities, attributes and relationships in accordance with the AER model 200 as described above.

Furthermore, the software 400 may have a creation module 404. The creation module 404 operates to translate the AER diagram created by the user through appropriate manipulation of the graphical user interface 402 into the records needed for the primary entity 14 and Attributes entity 16 of the third data store 18.

It should be further appreciated by the person skilled in the art that the above invention is not limited to the embodiments described. In particular, the following modifications and improvements may be made without departing from the scope of the present invention:

While tables, records and fields are usually associated with a fixed order of definition, entities and attributes as contemplated under this invention do not have a defined representation. Hence the exact implementation of entities and attributes can be left up to the specific implementation.

The Attributes entity 16 may include an “Update” or similarly named field. This field ideally is a Boolean field and provides information to the application code 22 as to whether it is permitted to change the data value recorded for the field. Thus, the third data store 18 is able to designate the data values associated with certain attributes as read-only.

Yet further fields may be added to the Attributes entity 16 to provide further functionality or restrictions. For instance, a “Conditional” attribute may be added. The “Conditional” attribute is ideally a Boolean expression of a type as already described that sets data integrity rules for the attribute. Hence, when the Boolean expression evaluates to “TRUE”, it is known that the data integrity rules set for the applicable attribute have been met.

The database schema 20 may incorporate error detection and handling systems to perform the synchronisation function in place of the use of change records. In such a configuration, the error detection and handling systems can on access, or periodically, check whether the database schema 20 is synchronised with the third data store 18. If the systems detect that the database schema 20 is out of synchronisation with the third data store 18, the systems may then contact the third data store 18 to get such information as is missing or otherwise needed to bring the database schema 20 back into synchronisation with the third data store 18.

Alternatively, the database schema 20 may each record a value representing a version of the third data store 18 under which they are operating. When a query is executed or a change in data seeks to be permanently committed, a comparison between the recorded version value and the current version value of the third data store 18 is made. If the comparison shows that the recorded version value is lower than the current version value of the third data store 18, the database schema 20 then queries the third data store 18 to get such information as is missing or otherwise needed to bring the database schema 20 back into synchronisation with the third data store 18.

In a yet further alternative configuration, the database schema 20 periodically, or as needed prior to executing a query or permanently committing a data change, contact the third data store 18 to get details of recent change records 30. These change records 30 are then assessed by the database schema 20 and, if not already made, implemented. In such a system, once a change record 30 has been read by the database schema 20, the third data store 18 presumes that it is aware of the change referenced by the change record 30 and is taking appropriate action relating to this change.

Where the third data store 18 is accessed by multiple instances of the same application code 22, and the application code 22 varies in synchronisation with the third data store 18, any of the aforementioned approaches to synchronisation may be modified to accommodate the multiple instances. For example, version control systems may be implemented, or, in the case of change records 30, the change record 30 may not be deleted until all instances of the application code 22 have implemented the change.

The translator module 24 may undertake any or all of the responsibilities of database engine 26.

The software 400 of the fourth embodiment may be adapted to provide yet further functionality to the developer. For instance, the user interface 402 may allow for the developer to set the parameters and functions for determination of summary and simple attributes.

In an alternative configuration, the execution of an initialisation procedure by way of a separate program may be omitted in favour of hardcoding the first and second record of the primary entity 14 into the application code 22. However, if this approach is adopted it is essential that the hardcoded records conform with the first and second record of the primary entity 14 at all times.

The initialisation records may include further information beyond details of the primary entity 14 and Attributes entity 16. For example, all of the records in the primary entity 14 and Attributes entity 16 may be provided.

The invention can also be implemented by omitting the primary entity 14 in favour of simply the Attributes entity 16. However, such an implementation removes the in-built type-safety of the primary entity 14-Attributes entity 16 structure and thus may result in additional error checking requirements being placed on the application code 22.

The bootstrap procedure may also form part of a standard library of the software operating the third data store 18.

The translator module 24 may be enhanced by way of a modification of the Load and Commit functions to allow for atomic read and writes (particularly in a multi-user environment). This can be achieved by sending a set of Attribute, Record pairs to the Load function, and a set of commands to the Commit function. In this way, the translator module 24 can both optimise its queries of the database schema 20 while ensuring that all values created and committed occur within one transaction.

In a multi-user environment, the third data store 18 may be held in the working memory of a server (not shown), while programmers working on application code 22 which utilises this third data store 18 may be working on one or more client computers that are in data communication with this server.

It is to be appreciated by the person skilled in the art that all references to servers, processing devices, etc. are references to such equipment as would be readily known to them. In the case of processing devices, this includes desktop and notebook computers, tablets and, in some situations, even smart mobile phones.

It should be further appreciated by the person skilled in the art that the invention is not limited to the embodiments described above. Additions or modifications described, where not mutually exclusive, can be combined to form yet further embodiments that are considered to be within the scope of the present

We claim:

1. A data structure for software comprising a table of attributes, where each record of the attributes table includes additional information, such that application code of the software is only able to reference the data value associated with the attribute as stored in the database schema by way of the attributes referenced in the data structure, the database schema thereby able to independently determine how to implement the attribute records.

2. A data structure for software according to claim 1, further comprising a table of entities and where each record of the attributes table references a record of the entity table, the database schema operable to independently determine the implementation of the relationship between the data stored in relation to the entity records and attributes records.

3. A data structure for software according to claim 1 or claim 2, where the data structure is implemented in a third data store.

4. A data structure for software according to claim 2 or claim 3, where the first records of the entity table are a reference to the existence of the entity table and the attributes table.

5. A data structure for software according to any preceding claim, where each record in the attributes table includes fields that define a Boolean expression or function.

6. A data structure for software according to claim 4, where the Boolean expression includes a reference to an attribute in the attributes table that itself references a further Boolean expression.

7. A data structure for software according to any preceding claim, further comprising a form table linked to a set of records in a first field table, each record in the set of records being associated with a record in the attributes table such that the application code is able to use the data contained in the form table and first field table to create a desired form as and when needed.

8. A data structure for software according to any preceding claim, further comprising a report table, the report table linked to a set of records in a second field table, each record in the set of records being associated with a record in the attributes table such that the application code is able to use the data contained in the report table and second field table to create a desired report as and when needed.

9. A data structure for software according to claim 7 or claim 8, further comprising a format table, each record in the format table include formatting information in respect of an element of either a record in the form table or a record in the report table.

10. A data structure for software according to any preceding claim, further comprising a table for recording application behaviour details.

11. A data structure for software according to any preceding claim, where the attributes table further includes a field, the value of which indicates to the application code whether it is permitted to change the data value of that attribute.

12. A data structure for software according to any preceding claim, where the attributes table further includes a field, the Boolean expression used to evaluate the field value is representative of the data integrity rules for that attribute.

13. A method of populating a data structure for software according to any one of claims 1 to 12, comprising the steps of:
identifying entities related to the software;
identifying attributes for each identified entity;
identifying relationships between identified entities;
modifying all identified relationships such that only 1:N relationships exist between identified entities;
adding an attribute to each identified entity on the N side of a 1:N relationship being a foreign key back to the other identified entity of the 1:N relationship; and
adding a new record to the entities table representing each entity identified according to the preceding steps;
adding a new record to the Attributes Entity representing each attribute identified according to the preceding steps and associating the attribute with the corresponding record of the entities table matching the entity the attribute is identified with.

14. A method of populating a data structure for software according to claim 13, where the step of modifying all identified relationships such that only 1:N relationships exist between identified entities includes the substep of eliminating all 1:1 relationships between identified entities by combining the two identified entities into a single entity.

15. A method of populating a data structure for software according to claim 13 or claim 14, where the step of modifying all identified relationships such that only 1:N relationships exist between identified entities includes the substep of eliminating all M:N relationships between identified entities by transforming the relationship into its own entity with a 1:N relationship back to the original identified entities.

16. A method of populating a data structure for software according to any one of claims 13 to 15, where the method further includes the step of identifying at least one summary attribute for at least one entity.

17. A method of populating a data structure for software according to any one of claims 13 to 16, where the method further includes the step of identifying at least one simple attribute for at least one entity.

18. A method of populating a data structure for software according to any one of claims 13 to 17, where the method further includes the step of creating as the first records in the entity table a record relating to the entity table and a record relating to the attribute table.

19. Software recorded on a computer readable medium that, when executed by an appropriate processing device utilises a data structure as defined in any one of claims 1 to 12.

20. Software according to claim 19, where the data structure is implemented in a third data store.

21. Software according to claim 19 or claim 20, where the application code operates to execute an initialisation procedure, the initialisation procedure operable to read the first records of the attributes table.

22. Software according to claim 19 or claim 20, as ultimately dependent on claim 2, where the application code operates to execute an initialisation procedure, the initialisation procedure operable to read the first records of the entity table and thereby provide the application code with details of the entity table and the attributes table for future referencing.

23. Software according to any one of claims 19 to 22, where a query for data values from the database schema requires a first query of the attributes table with at least some of the results of the query being used as the basis for a second query of the database schema.

24. Software according to claim 23, where the second query is made through a translator module 24, the translator module 24 operable to translate the second query into an appropriate query of the database schema.

25. Software according to claim 24, where the translator module 24 executes queries through a set of load functions.

26. Software according to claim 25, where the load function receives as its execution parameters, an attribute as identified in the attributes table and a record.

27. Software according to claim 25 or claim 26, where the information obtained from the set of load function is used to:
determine the relevant table in the database schema;
determine the referential position of the relevant table in the database schema; and
determine the type function to be returned.

28. translator module 24 Software according to claim 26, where the results of the query are returned as the same type as the type of the attribute parameter.

29. translator module 24A data structure for software according to any one of claims 19 to 28, where the application code and database schema have synchronisation means for synchronising with the data structure.

30. Software recorded on a computer readable medium that, when executed by an appropriate processing device, allows a user by way of a graphical user interface to:
identify entities related to the software;
identify attributes for each identified entity;
identify relationships between identified entities;
modify all identified relationships such that only 1:N relationships exist between identified entities; and
add an attribute to each identified entity on the N side of a 1:N relationship being a foreign key back to the other identified entity of the 1:N relationship,
the software further including populating means, the populating means operable to add a new record to an entities table representing each identified entity and add a new record to an Attributes Entity representing each identified attribute and associate the identified attribute with the corresponding record of the entities table matching the entity the attribute has been identified with.
